(19) United States
(12) Patent Application Publication
(10) Pub. No.: US 2010/0012076 A1
(43) Pub. Date: Jan. 21, 2010

(54) ENGINE COMBUSTION BOOSTER

(76) Inventor: Kuei-Lan Chen, Tainan (TW)

Correspondence Address: Kuei-Lan Chen, 235 Chung - Ho, Box 8-24, Taipei, TW

(21) Appl. No.: 12/174,622

(22) Filed: Jul. 16, 2008

(51) Int. Cl. F02M 35/02

(52) U.S. Cl. 123/198 E

(57) ABSTRACT

An engine combustion booster comprises a body, an air filter device, two elongate adjusting screws, and two vacuum valve units and a joint. The joint is assembled to the chamber of the body; an upper end of the joint has a cover plate. A lower side of the cover plate has a threaded portion for threading the female thread of the chamber. The cover plate is extended with a tube. The channel penetrates through the tube and the cover plate. Two ends of the channel are wider than a middle portion of the channel; and a bottom of the cover plate has an annular recess for receiving a washer.

### FIELD OF THE INVENTION

The present invention relates to engines, in particular to an engine combustion booster, which has a joint. The joint has a tube with a channel for inputting cleaning agent which can be sprayed out. A vacuum unit serves to absorb air into the engine for removing the accumulated carbon so as to increase the combustion efficiency.

### BACKGROUND OF THE INVENTION

In U.S. Pat. No. 5,738,078, “BURNING EFFECT BOOSTER FOR AN ENGINE”, in that a burning effect booster for an engine is disclosed, which comprises: a body; two elongate adjusting screws, two vacuum units. The booster is fixed on a proper location on a cylinder of an engine of an automobile after being assembled together, the two nozzles respectively connected with a soft tube tightly with a front end and a rear end of an intake manifold of the engine. The adjusting screws properly adjusted for controlling filtered clean air to pass through the passageway depending on air intake volume, compression rate and the number of throttles of the engine. The pistons receives sucking force in accordance with vacuity in the intake manifold produced by the engine. The pistons then sliding back and forth in the cylindrical threaded members so as to permit proper filtered clean air flow through the nozzles in the intake manifold of the engine in due time as to supplement air needed so that gas in the engine may burn completely, subsequently boosting horsepower of the engine, and exhausted waste gas may be reduced, with air pollution being reduced accordingly to obtain effect in saving energy.

The above-mentioned structure has the effect of filtering the input air so that the fuel can be burnt completely, after combustion, the residue carbon left in the engine will accumulate which is necessary to be removed for improving the combustion effect.

### SUMMARY OF THE INVENTION

The present invention is aimed to provide an engine combustion booster, which can remove the accumulated carbon in the engine effectively with an easy and convenient operation so as to improve the combustion efficiency of the engine.

To achieve above object, the present invention provides an engine combustion booster comprises a body, an air filter device, two elongate adjusting screws, and two vacuum valve units and a joint. The joint being assembled to the chamber of the body; an upper end of the joint having a cover plate; a lower side of the cover plate having a threaded portion for threading the female thread of the chamber; the cover plate is extended with a tube; the channel penetrating through the tube and the cover plate; two ends of the channel being wider than a middle portion of the channel; and a bottom of the cover plate having an annular recess for receiving a washer.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 shows the use of the present invention, in that the accumulated carbon is removed.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

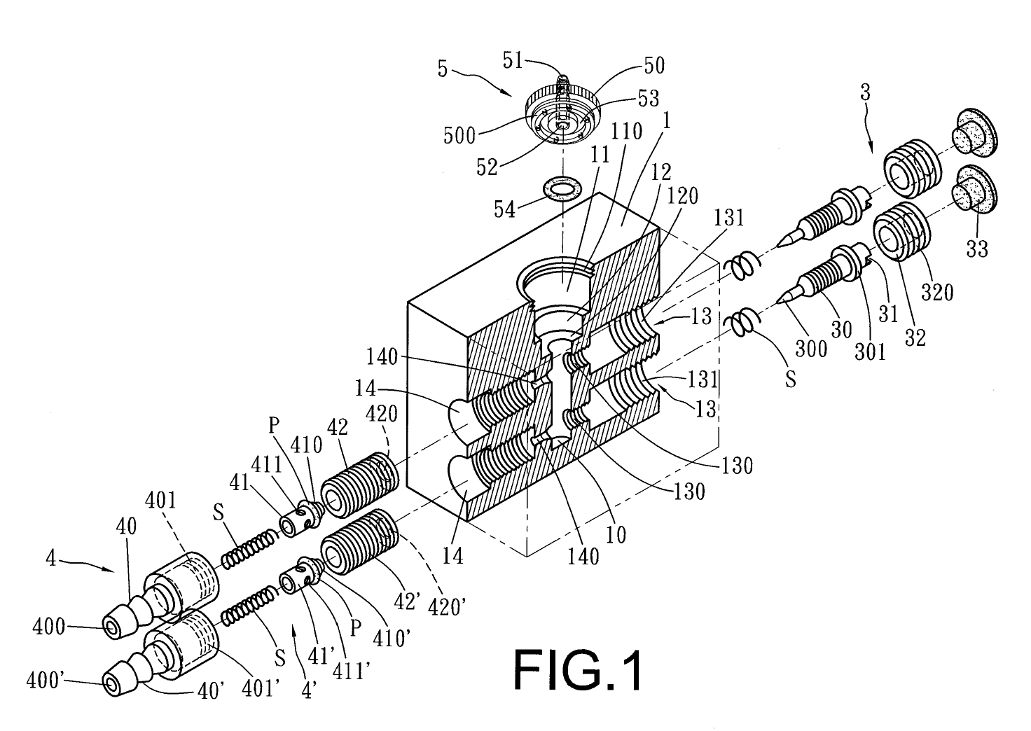

A preferred embodiment of a burning effect booster for an engine in the present invention, as shown in FIG. 1, includes a body 1, an air filter device 2, two elongate adjusting screws 3, 3, and two vacuum valve units 4, 4 and a joint 5 as main components combined together.

The body 1 has a deep passageway 10 in the intermediate portion, a round chamber 11 located just on the passageway and having a larger diameter than that of the passageway 10, female threads 110 formed on an upper portion of the chamber 11, an engage edge 12 provided between the chamber 11 and the passageway 10, two recessed holes 13,13 formed sidewise in a right side and female threads 130 formed to extend inward from the bottom of each recessed hole 13 and reaching and communicating with the passageway 10, two recessed chambers 14, 14 formed sidewise in a left side, a cone-shaped connect hole 140 extending from the bottom of each chamber 14 to reach and communicate with the vertical passageway 10.

The two elongate adjusting screws 3, 3 respectively have a threaded rod 30 provided with male threads, and a spring S fits around the threaded rod 30 of each adjusting screw 3. A part of the threaded rod 30 is formed with threads. Each adjusting screw 3 together with each spring S is inserted in each recessed hole 13. Further, each adjusting screw 3 has a notch 31 in an outer end surface projecting out of each recessed hole 13, and each threaded rod 30 has a pointed portion 300 and engages the female threads 130 of each recessed hole 13. The threaded rod 30 has a flange 301 and one end of the spring S resists against the flange 301. A cap 32 is provided to fix on the outer end of each adjusting screw 3 to keep each adjusting screw 3 in place. An outer periphery of cap 32 has an outer thread 320. A distal end of the cap 32 is sealed by a plug 33.

The two vacuum units 4, 4′ are respectively disposed in the two recessed chambers 14, 14′, respectively having a nozzle 40, 40′ provided with a through hole 400, 400′ and female threads 401, 401′, a piston 41,41′ shaped like a bullet, and a spring S inserted in the female threaded 401, 401′. Each piston 41, 41′ has a pointed head 410, 410′, an O-shaped ring P fitted around the lower end of the pointed head 410, 410′, and a cylindrical portion extending to the left from the piston head 410. 410′ and several air holes 411, 411′ bored in the cylindrical portion. Further, the spring S extends in the cylindrical portion. A cylindrical threaded member 42, 42′ is provided, having male threads to engage the female threads 401,401′ of the nozzle 40, 40′, a hollow interior for each piston 41, 41′ to fit therein, and a center hole 420. 420′ in a right end for the point of the head 410, 410′ to protrude out.

The joint 5 is assembled to the chamber 11 of the body 10. The upper end of the joint 5 has a cover plate 50. A lower side of the cover plate 50 has a threaded portion 500 for threading the female thread 110 of the chamber 11. A center of the cover plate 50 is extended with a tube 51. The channel 52 penetrates through the tube 51 and the cover plate 50. Two ends of the channel 52 are wider than a middle portion of the channel 52. A bottom of the cover plate 50 has an annular recess 54 for receiving a washer 54.

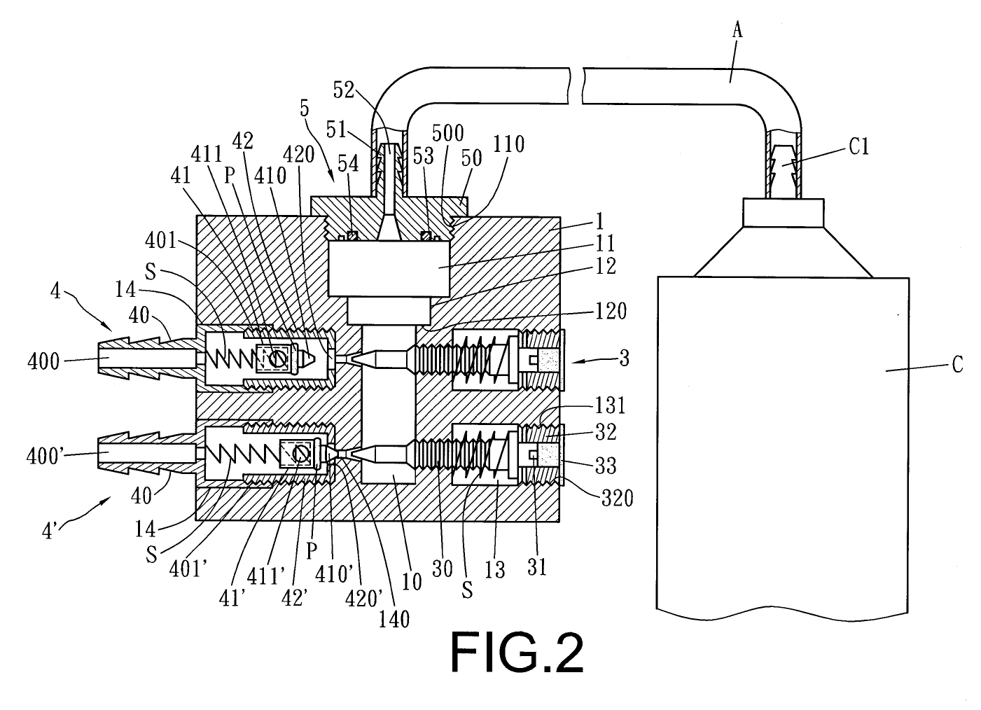

Referring to FIG. 2, in use, the joint 5 is assembled to the body 1. A soft tube A is connected with the tube 51 to a pipe C1 with cleaning agent C therein. When an engine is actuated, the cleaning agent C will be absorbed into the body 1 through the channel 52 of the joint 5. Since two ends of the channel 52 are wider than a middle portion of the channel 52. The cleaning agent into the body 1 will be extruded and then sprayed into the body 1. Then it is absorbed into the vacuum units 4, 4′ so as to remove the carbons in the engine.

Therefore, the accumulated carbons in the engine are removed so as to improve the combustion efficiency. The operation is easy and convenient.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An engine combustion booster comprising a body, an air filter device, two elongate adjusting screws, and two vacuum valve units and a joint;
the body having a deep passageway in the intermediate portion, a chamber located just on the passageway, female threads formed on an upper portion of the chamber, two recessed holes formed sidewise in a right side and female threads formed to extend inward from the bottom of each recessed hole and reaching and communicating with the passageway, two recessed chambers formed sidewise in a left side, a hole extending from the bottom of each chamber to reach and communicate with the vertical passageway;
the two elongate adjusting screws respectively having a threaded rod provided with male threads; a part of the threaded rod being formed with threads; each adjusting screw being inserted in each recessed hole; and each threaded rod having a pointed portion and engaging the female threads of each recessed hole;
the two vacuum units respectively disposed in the two recessed chambers, respectively having a nozzle; a piston, and a cylindrical threaded member; each piston having a pointed head corresponding to the head of the pointed portion of the piston; a middle and a rear section of the piston being hollowed for assembling a spring; and a plurality of air holes being formed in the piston; and
the joint being assembled to the chamber of the body; an upper end of the joint having a cover plate; a lower side of the cover plate having a threaded portion for threading the female thread of the chamber; the cover plate being extended with a tube; the channel penetrating through the tube and the cover plate; two ends of the channel being wider than a middle portion of the channel; and a bottom of the cover plate having an annular recess for receiving a washer.
